(19) United States
(12) Patent Application Publication
(10) Pub. No.: US 2010/0070524 A1
(43) Pub. Date: Mar. 18, 2010

(54) APPARATUS AND METHOD FOR PARSING DOMAIN PROFILE IN SOFTWARE COMMUNICATION ARCHITECTURE

(76) Inventors: Myung-Nam Bae, Daejon (KR); Byung-Bog Lee, Daejon (KR); Ae-Soon Park, Daejon (KR)

Correspondence Address: LADAS & PARRY LLP, 224 SOUTH MICHIGAN AVENUE, SUITE 1600, CHICAGO, IL, 60604, US

(21) Appl. No.: 12/514,694

(22) PCT Filed: Oct. 30, 2007
(86) PCT No.: PCT/KR2007/005398

§ 371 Date: May 13, 2009

(30) Foreign Application Priority Data
Nov. 14, 2006 (KR) 10-2006-0112168

(51) Int. Cl. G06F 17/00; G06F 17/30

(52) U.S. Cl. 707/769; 715/234; 707/E17.014

(57) ABSTRACT

An apparatus and method for parsing a domain profile in SCA are provided. The apparatus includes an open profile interface and an XML parser. The open profile interface receives a domain profile name with a DOM tree generation request from a framework, transfers the received domain profile name according to the DOM tree generation request, generates a search query corresponding to a request of information in a DOM tree for the domain profile, directly extracts corresponding information from the DOM tree using the generated search query, and provides the extracted information to the framework. The XML parser receives the domain profile name from the open profile interface and generates a DOM tree of a corresponding domain profile.

### TECHNICAL FIELD

The present invention relates to an apparatus and method for parsing a domain profile in a software communication architecture (SCA); and, more particularly, to an apparatus and method for parsing a domain profile in a SCA in order to prevent a memory from being wasted due to the overlapping of parsing and hard coding by sustaining and managing a document object model (DOM) tree, which is a result of parsing a SCA based domain profile and by directly extracting corresponding information from the DOM tree which is independent from an eXtensible markup language (XML) parser.

This work was supported by the Information Technology (IT) research and development program of the Korean Ministry of Information and Communication (MIC) and/or the Korean Institute for Information Technology Advancement (IITA) [2005-S-404-32, “Research & development on Mobile Terminal Technology based on 3G evolution”].

### BACKGROUND ART

Software communication architecture (SCA) was developed by a joint tactical radio system (JTRS) and a joint program executive office (JPEO) in order to provide mutual recognition among communication systems. The SCA provides the portability of software and hardware and guarantees a proper level of configuration ability.

The SCA also provides the heterogeneous hardware and software integrated environment based on the common object request broker architecture (CORBA) middleware, which is the industrial standard of distributed object model.

The domain profile of the SCA describes the relationship among the components, logical locations, mutual recognition, and parameters using the extensible markup language (XML). The core framework allocates, sustains, and manages a target resource, a device, and application using the domain profile.

That is, the domain profile is described in XML which is unstructured and self-describing language. The core framework independently accesses the domain profiles, the XML document, and obtains the information therefrom.

Hereinafter, the SCA will be described in more detail with reference to FIG. 1.

As shown in FIG. 1, the SCA uses a real-time embedded operating system 11 supporting multi-thread, uses a CORBA 12 as a message transfer technology for distributed processing environment, and provides interfaces and core services for software and hardware layers through a framework 15.

The domain profile 14 is a file that includes the relationship, a logical location, a mutual recognition, and parameters among software or hardware device components by XML. A profile parser 13 parses a plurality of domain profiles 14 and provides the parsed domain profiles 14 to the framework 15 as individual information.

The user communication functions including digital signal processing, protocol processing, and external input/output access are performed through the application 16. The application 16 uses interfaces and services provided by the framework 15.

Hereinafter, the types of domain profiles will be described with reference to FIG. 2.

As shown in FIG. 2, the domain profiles, which describe hardware devices and software components of the SCA system domain, includes Software Package Description (SPD) 21, Software Component Descriptor (SCD) 22, Software Assembly Descriptor (SAD) 23, Properties Descriptor PD 24, Device Package Descriptor (PDP) 25, Device Configuration Descriptor (DCD) 26, Profile Descriptor (PD) 27, which contain information about individual component.

The Software Package Description (SPD) 21 describes information for identifying an embodying object of a unit software component.

The Software Component Descriptor (SCD) 22 contains information about interfaces provided or used by components.

The Software Assembly Descriptor (SAD) 23 includes information about components constituting an application.

The Properties Descriptor PD 24 has unique characteristics information applied to a package.

The Device Package Descriptor (PDP) 25 contains information used for identifying devices to install.

The Device Configuration Descriptor (DCD) 26 includes information about devices and information about device configuration.

The Profile Descriptor (PD) 27 has domain profiles to use.

In the SCA, the domain profile parser 13 parses the domain profiles 14 and generates a DOM tree. Then, the domain profile parser 13 directly extracts information from the DOM tree, translates the extracted information as the data pattern dependable from a corresponding framework, and stores the translated data in the framework. The domain profile parser 13 searches corresponding data according to the request of the framework 15 and provides the searched data to the framework 15.

Since the conventional domain profile parser 13 extracts all information from the DOM tree on each request by hard-coded parsing methods and stores the internal data structure, the conventional domain profile parser 13 has following shortcomings. Since the conventional domain profile parser 13 repeatedly parses the domain profile, the conventional domain profile parser 13 takes more time for parsing. Due to the hard coding, the conventional domain profile parser 13 needs more memory space. Particularly, the conventional domain profile parser 13 is dependable to a predetermined XML parser, and it is difficult to adapt to other XML Parser 31 or 34 that is satisfied with the requirement of a mobile terminal (for example, memory usage, timing constraints).

Therefore, there is a demand for developing a method for directly extracting information from a DOM tree according to the request from a framework.

### DISCLOSURE OF INVENTION

### Technical Problem

An embodiment of the present invention is directed to providing an apparatus and method for parsing a domain profile, which quickly and effectively parses the domain profile without frequent overlapping of parsing, hard-cording, and additional storage structure by providing a high-level XML parsing interface that excludes the generation of additional storage structure for storing all information in a DOM tree and that has a function of selecting, limiting, and referring a path for directly accessing information in a domain profile having self-describing characteristics and by providing a management function for sustaining, removing, and sharing a DOM tree generated through the parsing a system domain profile that describes component information in a SCA based mobile terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### TECHNICAL SOLUTION

In accordance with an aspect of the present invention, there is provided a domain profile parsing apparatus in a SCA including: an open profile interface processing unit for receiving a domain profile name with a document object model (DOM) tree generation request from a framework, transferring the received domain profile name according to the DOM tree generation request, generating a search query corresponding to a request of information in a DOM tree for the domain profile, directly extracting corresponding information from the DOM tree using the generated search query, and providing the extracted information to the framework; and an extensible markup language (XML) parser for receiving the domain profile name from the open profile interface processing unit and generating a DOM tree of a corresponding domain profile.

In accordance with another aspect of the present invention, there is provided a method for parsing a domain profile in SCA, including the steps of: a) transferring a domain profile name received with a document object model (DOM) tree generation request from a framework to an extensible markup language (XML) parser; b) generating a DOM tree for the domain profile received from the XML parser; c) generating a search query corresponding to a request of information in a DOM tree for the domain profile; and d) directly extracting corresponding information from the DOM tree and providing the extracted information to the framework.

### ADVANTAGEOUS EFFECTS

As described above, the apparatus and method for parsing a domain profile according to an embedment of the present invention can quickly and effectively parse the domain profile without frequent overlapping of parsing, hard-cording, and additional storage structure by providing a high-level XML parsing interface that excludes the generation of additional storing structure for storing all information in a DOM tree and that has a function of selecting, limiting, and referring a path for directly accessing information in a domain profile having self-describing characteristics and by providing a management function for sustaining, removing, and sharing a DOM tree generated through the high-level XML parsing interface in parsing a system domain profile that describes hardware device and software component information in the mobile terminal based SCA framework.

The apparatus and method for parsing a domain profile according to an embodiment of the present invention provides a system for using a high-level interface including a limitation operator, a conditional operator, and a reference operator, which are adapted according to the parsing of a domain profile without using a low-level DOM API in parsing a SCA based domain profile. Therefore, a size of a code used for parsing can be minimized.

Furthermore, the apparatus and method for parsing a domain profile according to an embodiment of the present invention can provide a flexible domain profile management system for preventing the parsing of a domain profile from overlapping and for improving memory efficiency and process performance through an interface for sustaining and managing the profile parsing result and partially reconfiguring a DOM tree in SCA.

In order to minimize frequent interacts between the framework and the parser, the apparatus and method for parsing a domain profile according to an embodiment of the present invention can also provide a system for generating a data structure that is sequenced or structured in a domain profile viewpoint.

### BRIEF DESCRIPTION OF THE DRAWINGS

FIG. 1 is a diagram illustrating software communication architecture (SCA) according to the related art.

FIG. 2 is a diagram showing a domain profile according to the related art.

FIG. 3 is a block diagram illustrating a domain profile parsing platform for software communication architecture in accordance with an embodiment of the present invention.

FIG. 4 is a diagram depicting a class structure of an open profile interface in accordance with an embodiment of the present invention.

FIG. 5 is a diagram showing an example of a search query in accordance with an embodiment of the present invention.

FIG. 6 is a diagram illustrating a DOM interface in accordance with an embodiment of the present invention.

FIG. 7 is a block diagram showing a domain profile parsing apparatus in software communication architecture in accordance with an embodiment of the present invention.

FIG. 8 is a flowchart of a method for parsing a domain profile in software communication architecture in accordance with an embodiment of the present invention.

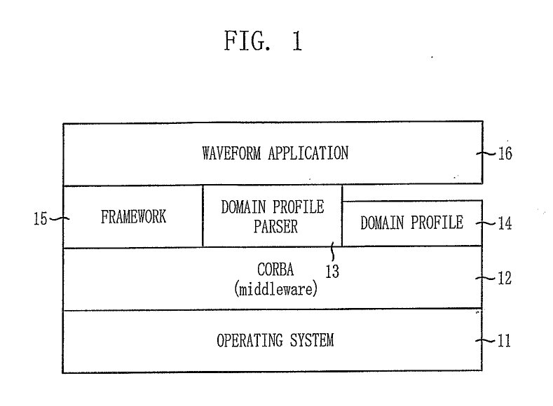

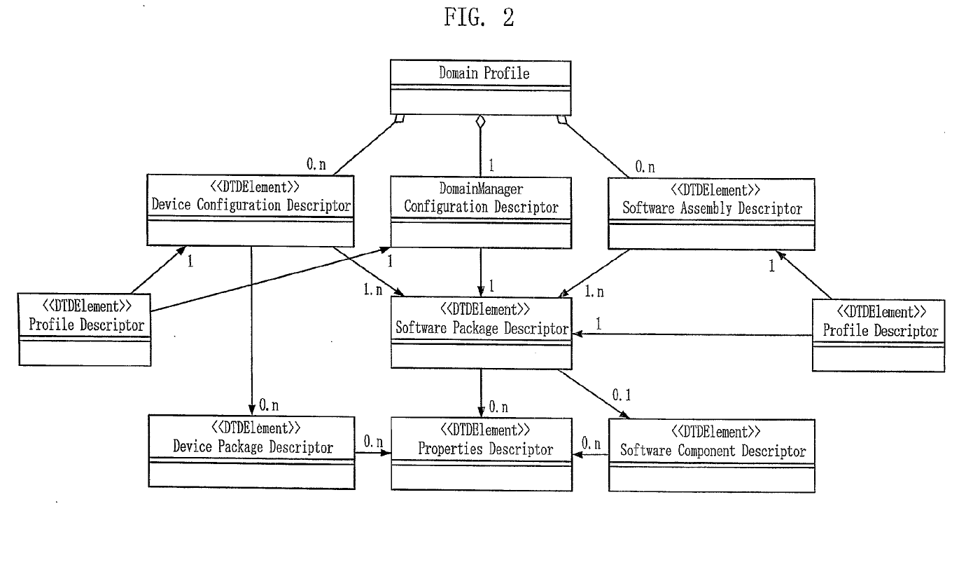

### BEST MODE FOR CARRYING OUT THE INVENTION

The advantages, features and aspects of the invention will become apparent from the following description of the embodiments with reference to the accompanying drawings, which is set forth hereinafter.

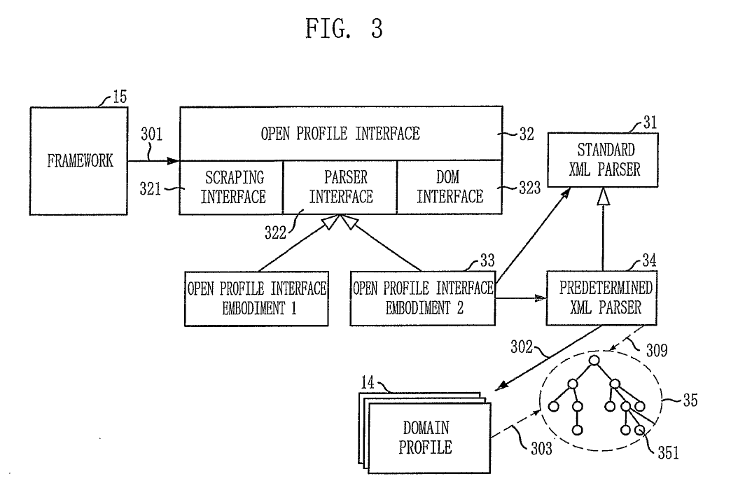

FIG. 3 is a block diagram illustrating a domain profile parsing platform in software communication architecture in accordance with an embodiment of the present invention.

As shown in FIG. 3, a framework 15 requests a parsing result to a standard XML parser 31 through an open profile interface 32 instead of directly calling the standard XML parser 31 at step S301. Since the open profile interface 32 is defined as ‘CORBA IDL’, a profile interface embodiment 33 is a CORBA servant.

The open profile interface 32 includes a scraping interface 321, a DOM interface 323, and a parser interface 322. The scraping interface 321 provides XML parsing operators enhanced for retrieving a XML parsing result according to a framework viewpoint rather than a general XML data extracting view point. The DOM interface 323 provides operators for managing the DOM tree parsed and generated by the standard XML parser 31 or the predetermined XML parser 34. The parser interface 322 selectively adds a complex data structure in a framework viewpoint.

A SCA framework vender must implement open profile interface embodiment 33, following the open profile interface specification 32, that has scraping interface 321, parser interface 322, and dom interface 323.

The open profile interface embodiment 33 can select one of an interface to the standard XML parser 31 and an interface to a predetermined XML parser embodiment 34 or some XML parser suitable for a mobile terminal with a limited constraints. Such interfaces request the parsing of a domain profile 14 described in XML at step S302 and obtain a DOM tree 35 as a result at step S303.

The data request of the framework at the step S301 is mapped to a data extracting interface for the DOM tree 35 through the interface embodiments. Therefore, the framework 15 enables the XML parsing process performed independently and the parsing process performed efficiently and flexibly.

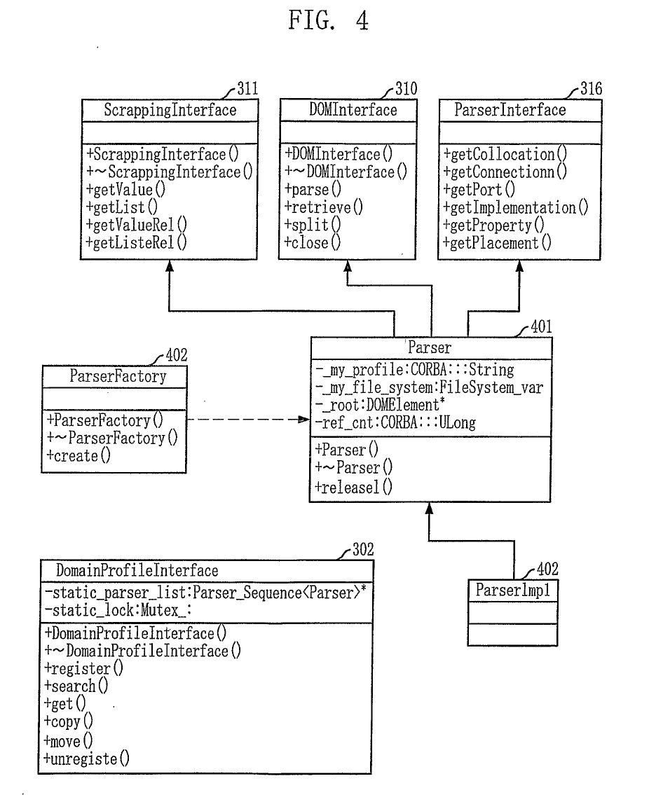

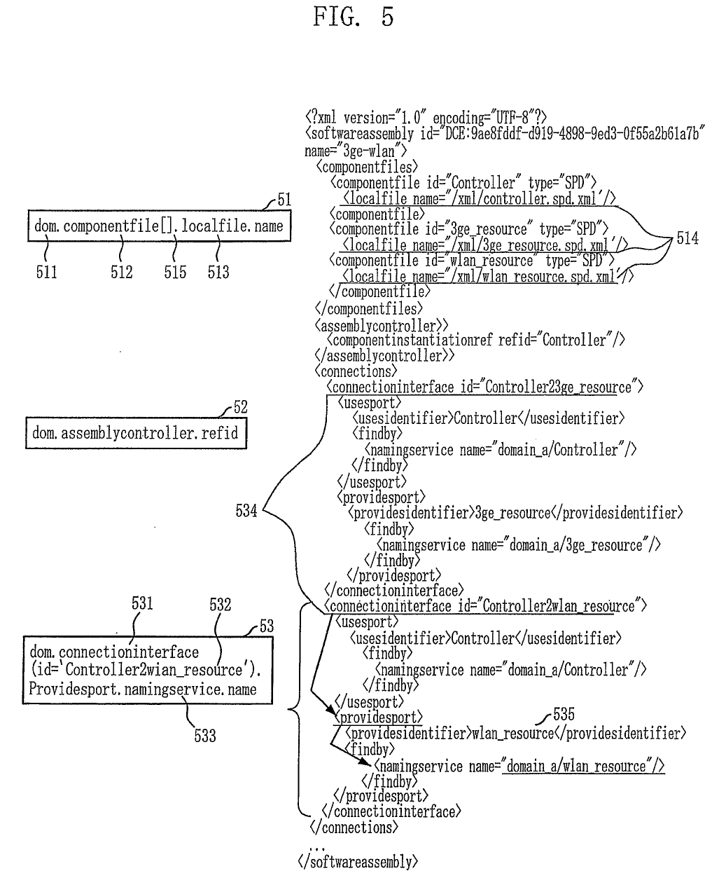

Hereinafter, the open profile interface 32 will be described in detail with reference to FIGS. 4 and 5.

As shown in FIG. 4, the open profile interface 32 includes a scraping interface 321, a DOM interface 323, and a parser interface 322. A parser factory 402 can generates a parser 401 for parsing the domain profile 14. A parser 401, the minimized common interface, must be guaranted in the open profile interface embodiment 33 by all SCA framework vender.

In order to exclude the allocating and the releasing an unnecessary memory and the overlapping of parsing, an example of using high-level data extracting operators required by a framework 15 will be described with reference to FIG. 5.

As shown in FIG. 5, the scraping interface 321 includes path indications, selection conditions, limitation conditions, and reference indications.

For example, an scraping interface command for requesting the extraction of the location of a profile for three resources can be defined as “dom.componentfile[].localfile.name” 51.

In the scraping interface command, dom 511 denotes a highest-level node of a DOM tree 35. If a path is formed from a ‘componentfile’ node 512 to a ‘localfile’ node 513, the scraping interface command extracts a ‘localfile’ element 513 and it's a ‘name’ attribute. In the command, limitation operator ‘[ ]’ 515 means all ‘componentfile’ that can be derived from ‘dom’ 511. that is no limitation conditions.

That is, the framework 15 can obtain a set of character string data String[ ] :[‘/xml/Controller.spd.xml’,‘/xml/3ge_resource.spd.xml’,‘/xml/wlan_resource.spd.xml’] as the result of requesting the extraction of a profile's a location. Herein, the location can be extracted by assigning sequence numbers like [1,2,5].

For another example, as a ‘refid’ attribute value, a character string String: ‘Controller’ can be obtained by defining a request of obtaining a ‘refid’ attribute of ‘ assembly-controller’ as “dom.Assemblycontroller.refid” 52. Since an ‘assemblycontroller’ element is uniquely defined in the SAD file, the contracted expression thereof can be possible.

For still another example, String:'‘domain_a/wlan_resource’ can be obtained by defining a request of extracting the CORBA naming context of resources that provide a port for CORBA connection, which is identified as ‘Controller2wlan_resource ’, as “ dom.connectointerface(id=‘Controller2wlan_resource’).providesport.namingservice.name” 53.

In the request 53, it is possible to clearly show a conditional expression using an id 532, which is the attribute node of a ‘connectioninterface’ node 534 to clearly describe a selection condition between two of ‘connectioninterface’ elements 534. The condition expression can be separated through a selection operator ‘( )’ 533.

In order to obtain a connection name of a target resource, String: ‘wlan_resource’, which is the value of ‘providesidentifier’ element 535, can be referred through “ dom.connectionterface(id=‘Controller2wlan_resource’).providesidentifier.value' instead of a ‘name’ attribute.

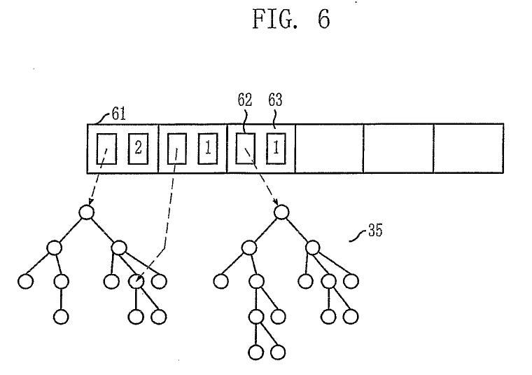

FIG. 6 is a diagram illustrating a DOM tree interface structure in accordance with an embodiment of the present invention.

As shown in FIG. 6, the DOM tree interface structure according to the present embodiment includes a DOM tree list 61, a pointer 62, and a reference count 63.

Herein, the DOM tree list 61 is formed in an index structure for fast access. Each item in the DOM tree list 61 includes a pointer pointing a real DOM tree and a reference count 63 for referring a real DOM tree.

The reference count 63 is initialized as 1 when it is registered at the DOM tree list 61, and has the number of times of referring to a target tree. The reference count 63 is used to decide a time of removing a corresponding DOM tree. Based on the reference count 63, the DOM interface 323 provides an operator for generating a DOM tree through parsing, an operator for releasing, sustaining, and assigning a DOM tree in a unit component in the framework 15, an operator for confirming whether a DOM tree for a requested domain profile is present or not, an operator for separating a repeatedly used part of a DOM tree to a new DOM tree, and an operator for removing unnecessary part of a DOM tree.

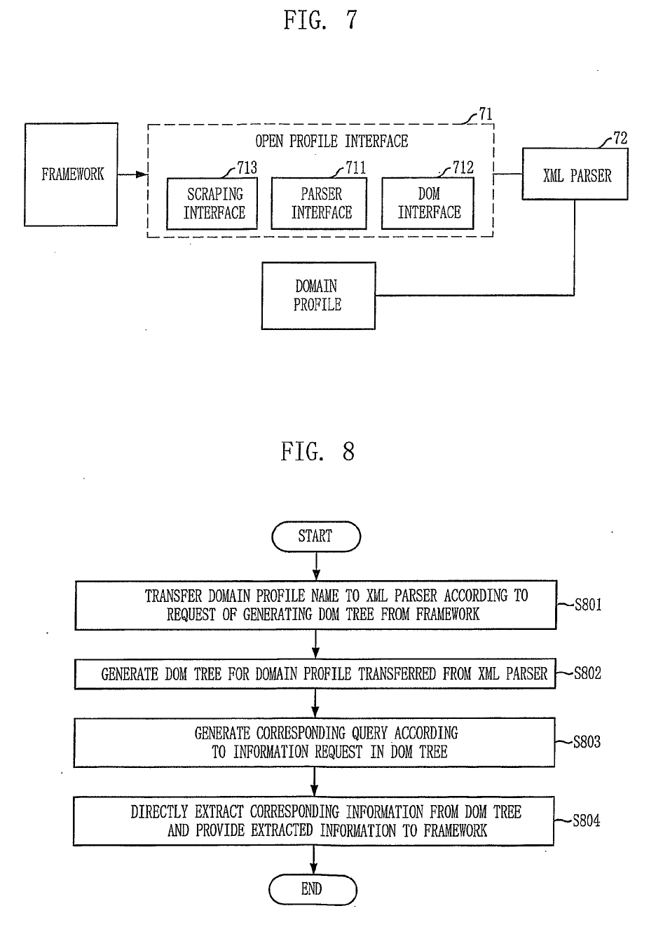

FIG. 7 is a block diagram showing a domain profile parsing apparatus in software communication architecture in accordance with an embodiment of the present invention.

As shown in FIG. 7, the domain profile parsing apparatus according to the present embodiment includes an open profile interface 71 and a XML parser 72. The open profile interface 71 receives a DOM tree generation request with a domain profile name from a framework 15 and transfers the domain profile name to the XML parser 72. Also, the open profile interface 71 generates a search query corresponding to a request of information in a DOM tree for the domain profile, directly extracts the corresponding information from the DOM tree, and provides the extracted information to the framework 15. The XML parser 72 receives the domain name from the open profile interface 71 and generates the DOM tree of a corresponding domain name.

The open profile interface 71 includes a parser interface 711, a DOM interface 712, and a scraping interface 713. The parser interface 711 calls the DOM interface 712 using a domain profile name transferred from the framework 15, transfers a request of information in a DOM tree for the domain profile, and transfers information extracted from the scraping interface 713 to the framework 15. The DOM interface 712 transfers a domain profile name transferred from the parser interface 711 to the XML parser 72, generates a corresponding search query according to the request of information in the DOM tree for the domain profile, and transfers the search query to the scraping interface 713. The scraping interface 713 directly extracts corresponding information from the DOM tree using the search query from the DOM interface 712.

The parser interface 711 transfers a request of removing a DOM tree from a framework to the DOM interface 712.

The parser interface 711 may convert the extracted information from the scraping interface 713 to corresponding data type and transfer the converted information.

Also, the parser interface 711 determines whether a DOM tree is additionally copied or referred twice or not, and transfers management commands to the DOM interface 712.

Furthermore, the parser interface 711 can inform the framework 15 that the generation of the DOM tree is completed at the DOM interface 712.

Moreover, the DOM interface 712 removes entire corresponding DOM tree or a predetermined part of the corresponding DOM tree according to a request of removing a DOM tree from the parser interface processor 711.

In addition, the DOM interface 712 generates search query for extracting requested information from the framework 15 if the requested information is included in a DOM tree and transfers the extracted information to the scraping interface 713. Then, the parser interface 711 collects corresponding information extracted from the scraping interface 713 and transfers the collected information to the framework 15.

FIG. 8 is a flowchart of a method for parsing a domain profile in software communication architecture in accordance with an embodiment of the present invention.

A user initializes a domain profile parsing apparatus to response to a request from a framework 15.

At step S801, a domain profile name received with a request of generating a DOM tree from the framework 15 is transferred to a XML parser 72. At step S802, the XML parser 72 generates a DOM tree for the transferred domain profile.

At step S803, a corresponding search query is generated according to a request of information in a DOM tree for the domain profile. The search query is shown in FIG. 5 as reference numerals 51, 52, and 53.

At step S804, the corresponding information is directly extracted from the DOM tree, and the extracted corresponding information is provided to the framework 15 through the parser interface 711.

That is, the scraping interface 713 extracts a node name from a query path of a search query transferred from the DOM interface 712.

Then, elements identical to the node name are extracted from the DOM tree and values or attribute values of the corresponding elements are extracted. Herein, if a conditional expression using an operator, such as, selection operator, limitation operator, and reference operator, exists in a search query, the result is extracted according to the conditional expression. the parser interface offer the extracted results to the framework 15 in format to use directly at the step S804.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 10-2006-0112168, filed in the Korean Intellectual Property Office on Nov. 14, 2006, the entire contents of which is incorporated herein by reference.

While the present invention has been described with respect to certain preferred embodiments, it will be apparent to those skilled in the art that various changes and modifications may be made without departing from the spirits and scope of the invention as defined in the following claims.

1. A domain profile parsing apparatus in a software communication architecture comprising:
an open profile interface processing means for receiving a domain profile name with a document object model (DOM) tree generation request from a framework, transferring the received domain profile name according to the DOM tree generation request, generating a search query corresponding to a request of information in a DOM tree for the domain profile, directly extracting corresponding information from the DOM tree using the generated query document, and providing the extracted information to the framework; and
an extensible markup language (XML) parsing means for receiving the domain profile name from the open profile interface processing means and generating a DOM tree of a corresponding domain profile.

2. The domain profile parsing apparatus of claim 1, wherein the open profile interface processing means includes:
a parser interface for calling a DOM interface processor using the domain profile name transferred from the framework, transferring a request of information in a DOM tree for the domain profile, and transferring extracted information to the framework;
a DOM interface for receiving the request of information from the parser interface, transferring the domain profile name received from the parser interface, generating a search query corresponding to a request of information in a DOM tree for the domain profile, and transferring the generated search query; and
a scraping interface for receiving the generated search query from the DOM interface, and directly extracting corresponding information from the DOM tree using the search query from the DOM interface.

3. The domain profile parsing apparatus of claim 2, wherein the DOM interface generates search query for extracting all of requested information if the DOM tree includes a plurality of information requested by the framework and transfers the generated search query to the scraping interface.

4. The domain profile parsing apparatus of claim 2, wherein the DOM interface processor divides or removes a corresponding DOM tree according to a request of dividing or removing a DOM tree received from a framework through the parser interface.

5. The domain profile parsing apparatus of claim 2, wherein the scraping interface extracts a node name from a query path in the received search query from the DOM interface, extracts an element identical to the node name from a DOM tree, and returns a value or an attribute value of a corresponding element.

6. The domain profile parsing apparatus of claim 5, wherein the scraping interface extracts a result according to a conditional expression if the search query includes the conditional expressions using operators such as selection operator, limitation operator, and reference operator.

7. A method for parsing a domain profile in software communication architecture (SCA), comprising the steps of:
a) transferring a domain profile name received with a document object model(DOM) tree generation request from a framework to an extensible markup language (XML) parser;
b) generating a DOM tree for the domain profile received from the XML parser;
c) generating a search query corresponding to a request of information in a DOM tree for the domain profile; and
d) directly extracting corresponding information from the DOM tree and providing the extracted information to the framework.

8. The method of claim 7, wherein in the step c), if a DOM tree includes a plurality of information requested by the framework, search query are generated for each of the requested information for extracting all of the requested information.

9. The method of claim 8, wherein in the step d), a node name is extracted from a query path in the search query, an element identical to the node name is extracted from the DOM tree, and a value or an attribute value of a corresponding element is returned.

10. The method of claim 9, wherein in the step d), if the search query includes conditional expression using an operator including a selection operator, a limitation operator, and a reference operator, a result is extracted according to the conditional expression.

11. The method of claim 10, further comprising the step of: removing a corresponding DOM tree according to a request of removing a DOM tree from the framework.
